(19) United States
(12) Patent Application Publication
(10) Pub. No.: US 2017/0351604 A1
(43) Pub. Date: Dec. 7, 2017

(54) HOST AND GARBAGE COLLECTION WRITE RATIO CONTROLLER

(71) Applicant: Futurewei Technologies, Inc., Plano, TX (US)

(72) Inventors: Xiangyu Tang, Santa Clara, CA (US); Yunxiang Wu, Santa Clara, CA (US)

(21) Appl. No.: 15/171,957

(22) Filed: Jun. 2, 2016

(51) Int. Cl. G06F 12/02; G06F 3/06

(52) U.S. Cl. CPC G06F 12/0246; G06F 3/0679; G06F 3/0616; G06F 3/064; G06F 3/0659; G06F 3/061; G06F 3/0665; G06F 2212/1036; G06F 2212/152; G06F 2212/214; G06F 2212/7205

(57) ABSTRACT

A method includes obtaining an average number of valid pages per block of the solid state storage device, obtaining an average number of invalid pages per block of the solid state storage device, determining a scaling factor as a function of the a number of free blocks in the solid state storage device, a steady state target number of free blocks, a high target number of free blocks, and a low target number of free blocks, and applying the scaling factor to the average number of invalid pages to control a ratio of host writes versus garbage collection writes to the solid state storage device.

### FIELD OF THE INVENTION

The present disclosure is related to host writes and garbage collection writes, and in particular to a controller that controls a ratio of host writes to garbage collection writes.

### BACKGROUND

NAND (Not AND) flash based solid state storage devices (SSDs) are becoming popular in the storage industry due to their resilience, speed, capacity, and low power consumption. However, unlike traditional hard-disk drives, NAND flash based solid state storage devices do not support in-place update of stored data. Instead, new data is written into a new free block. As free blocks are used up, a garbage collection (GC) process is used to collect valid data from dirty blocks in order to return these blocks to the free block pool. The GC process is a considerable overhead that can degrade performance of writing data from a host to the solid state drive.

Because flash memory must be erased before it can be rewritten, with much lower granularity of erase operations when compared to write operations, the process to perform these operations results in moving (or rewriting) user data more than once. Rewriting some data requires an already used portion of the flash memory to be read, updated and written to a new location, together with initially erasing the new location if it was previously used at some point in time. Larger portions of flash may be erased and rewritten than what are actually required by the amount of new data. This multiplying effect increases the number of writes required over the life of the SSD which shortens the time it can reliably operate. The increased number of writes also consumes bandwidth to the flash memory which mainly reduces random write performance to the SSD.

Conventional methods of balancing garbage collection (GC) writes to host writes, referred to as a GC ratio, often use a fixed schedule that is based on the number of free blocks to determine the number of GC writes. In one schedule, GC starts when there are about 64 blocks free in a SSD with a total 2000 blocks. As the number of free blocks shrinks, the GC ratio increases. When there are only 8 free blocks left, host writes are effectively throttled completely and most of the writes are GC writes. Note that there is no way to maintain the number of free blocks at a constant number during steady state operation of the SSD. Rather, a GC write ratio is used for whole ranges of a number of free blocks. Furthermore, the ratio may need to be manually adjusted for various SSD drive capacity configurations.

### SUMMARY

A method includes obtaining an average number of valid pages per block of the solid state storage device, obtaining an average number of invalid pages per block of the solid state storage device, determining a scaling factor as a function of the a number of free blocks in the solid state storage device, a steady state target number of free blocks, a high target number of free blocks, and a low target number of free blocks, and applying the scaling factor to the average number of invalid pages to control a ratio of host writes versus garbage collection writes to the solid state storage device.

A system includes a processor and a storage device coupled to the processor and having instructions for causing the processor to perform operations. The operations include obtaining an average number of valid pages value per block of the solid state storage device, obtaining an average number of invalid pages value per block of the solid state storage device, determining a scaling factor as a function of a number of free blocks in the solid state storage device, a steady state target number of free blocks, a high target number of free blocks, and a low target number of free blocks, and applying the scaling factor to the average number of invalid blocks to control a ratio of host writes versus garbage collection writes to the solid state storage device.

A computer readable storage device has instructions stored thereon for execution by a computer to perform operations. The operations include obtaining an average number of valid pages value per block of the solid state storage device, obtaining an average number of invalid pages value per block of the solid state storage device, determining a scaling factor as a function of a number of free blocks in the solid state storage device, a steady state target number of free blocks, a high target number of free blocks, and a low target number of free blocks, and applying the scaling factor to the average number of invalid blocks to control a ratio of host writes versus garbage collection writes to the solid state storage device.

### BRIEF DESCRIPTION OF THE DRAWINGS

FIG. 1 is a block diagram of a system having a solid state drive (SSD) and a controller to control a ratio of host writes to garbage collection writes according to an example embodiment.

FIG. 2 is a flowchart illustrating a method of determining a scaling factor for controlling a ratio of host writes to garbage collection writes according to an example embodiment.

FIG. 3 is a graph illustrating an example adaptive scaling factor according to an example embodiment.

FIG. 4 is a block diagram illustrating circuitry for implementing algorithms and performing methods according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

A garbage collection (GC) process for solid state drives (SSDs) is a considerable overhead that should be minimized. The overhead may include rewriting data and erasing NAND (Not AND) memory to consolidate data and free up larger blocks of memory. This overhead is measured in terms of write amplification (WA), which is defined as:

$$WA = \frac{host write + GC write}{host write} .$$

Host writes are writes to memory that include user data and other data that a host needs to store. GC writes are the writes associated with the GC process. WA is dependent on various factors such as user traffic, data management techniques, and especially over-provisioning (OP). Over-provisioning is the extra capacity a manufacture may put into a solid state drive (SSD) that is not accessible directly by the user. It is defined as

$$OP = \frac{total physical capacity - user capacity}{user capacity} .$$

The larger the OP, the longer one can wait to do GC, and thus fewer GC operations are conducted. This means that larger OP results in lower WA.

In order to maintain a consistent throughput, host writes and GC writes may be interleaved. For example, 5 GC writes are conducted for every 1 host write. The ratio of GC writes to host writes may be set so that a certain minimum amount of free space is always available in the SSD for maintenance purposes, while performing the fewest GC writes possible. In other words, if the number of GC writes per host write is too small, then free space may not be claimed fast enough, causing the free space to fall below a minimum threshold. And if the number of GC writes per host write is too big, then unnecessary GC overhead is incurred.

The problem of finding the correct GC write to host write ratio is not an easy one because it may depend on the amount of OP available on the SSD, the amount of free space available on the SSD, user traffic, and data management techniques, all of which can vary dynamically during the operation of the SSD.

WA, and therefore an optimal GC write ratio, is dependent foremost on effective over provisioning (EOP), which in turn is affected by the SSD configuration at each capacity point. A fixed table scheme would require time consuming calibration for each capacity point. Furthermore, the EOP of drives at the same capacity point could vary significantly due to the presence of bad blocks, which could range for 0 to 1.5% of the capacity. A fixed table would not be able to adjust to the number of bad blocks.

The EOP of an SSD drive may also vary during its lifetime due to different reasons, such as the number of bad blocks could grow by as much as another 1.5% during the lifetime of the drive. This will significantly affect WA, particularly for SSDs with OP around 7%˜10%.

Next generation SSD controllers may implement user data compression. This will increase the available EOP when the host is written certain traffic types. Next generation SSD controllers may also implement a variable rate error correction code (ECC). The variable rate ECC may reduce the available EOP during the middle and end of SSD's life. The changes in EOP during SSD operation make the design of a fixed table scheme difficult.

WA may be dependent on host traffic. For certain traffic, WA may be higher, while for other types of traffic, WA may be lower. A fixed schedule controller will have difficulty adjusting the host/GC write ratio to optimize performance for different traffic patterns.

Next generation SSD controllers may have advanced data management schemes where user data of different lifespan are segregated in the drive. WA may vary according to distribution of the data lifespan as well as segregation techniques. A fixed scheduler would have difficulty adapting to the varying levels of WA.

Various embodiments, of the inventive subject matter include an automated controller that mixes host writes with garbage collection writes in a balanced fashion such that the optimal amount of free space in a solid state drive will be maintained under varying drive configurations, user traffic, data management techniques, and other conditions.

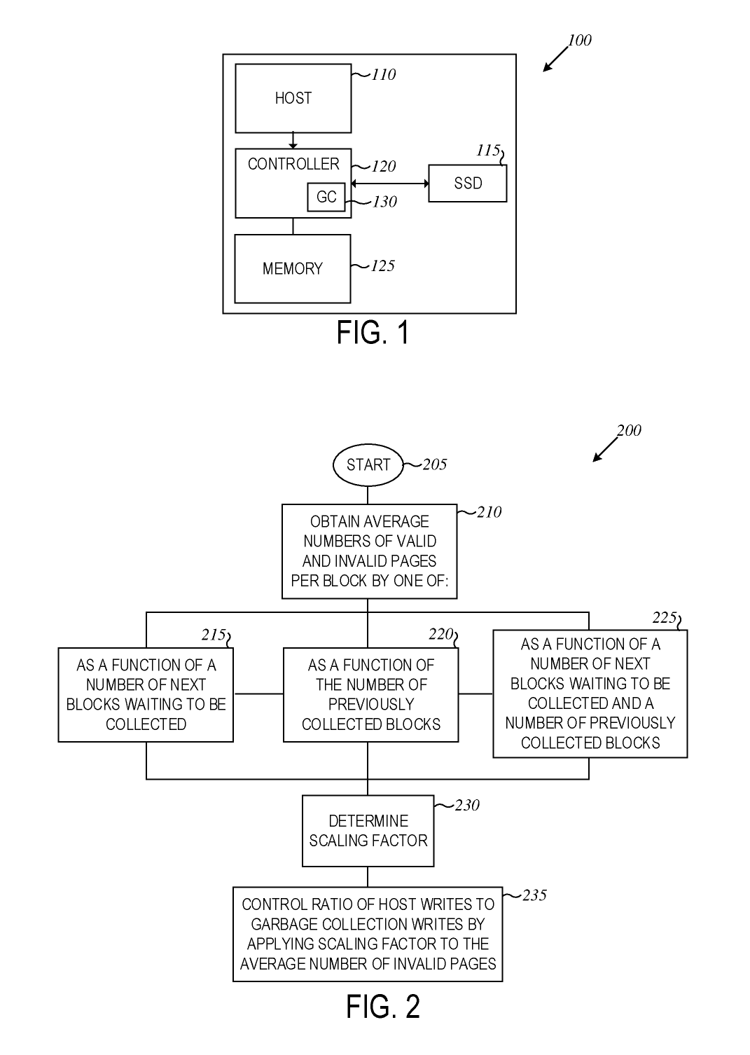

FIG. 1 is a block diagram of a system 100 that includes a host 110, solid state storage device (SSD) 115, controller 120, and memory 125. Host 110 may include one or more processors and its own memory, or may utilize memory 125 in some embodiments. Host 110 generates host writes that comprise data to be written to the SSD 115. The data may be user data or other data, such as application programs, operating system programs, and other data.

The host writes may be provided to controller 120 for controlling writing of the host writes to the SSD 115. In one embodiment, controller 120 includes a garbage collection module 130 which performs a garbage collection (GC) process and generates garbage collection writes. Several different GC methods are available and any may be used to perform GC on SSD 115 in various embodiments.

In one embodiment, the controller 120 receives the host writes and the GC writes and controls a ratio of GC writes to host writes via a scaling factor. The scaling factor is used to determine a number of GC writes and a number of host writes to schedule, which numbers form the GC ratio. To determine the scaling factor, the controller obtains information regarding a number of free blocks in the solid state storage device, an average number of valid pages, an average number of invalid pages, a steady state target number of free blocks, a high target number of free blocks, and a low target number of free blocks. The target numbers of free blocks may also be referred to as thresholds.

FIG. 2 is a flowchart illustrating a method 200 of determining the scaling factor. The method may be implemented in the controller 120 in one embodiment utilizing code stored in memory 125, or utilizing an ASIC. The method in further embodiments may be implemented on the host, or on a chip or chips that include the SSD storage elements.

Method 200 starts at 205. At 210, an average number of valid pages per block of the solid state storage device and an average number of invalid pages per block of the solid state storage device is obtained. The average numbers of pages may be provided by the GC 130 in some embodiments and may be derived in at least three different ways as indicated at 215, 220, and 225. At 215, the averages are a function of a number of blocks in a GC queue waiting to be collected. At 220, the averages are a function of a number of previously collected blocks. At 225, the averages are a function of a combination of the number of blocks in the queue waiting to be collected and the number of previously collected blocks. Obtaining the average numbers of pages based on the number of blocks in the GC queue waiting to be collected at 215 is forward looking and can adjust the write ratio more quickly according to SSD conditions. Obtaining the average numbers of pages based on the previously collected blocks at 220 may be used if the number of valid page counts in the GC queue cannot be obtained. Taking both the average number of pages based on the number of blocks in the GC queue and the number of previously collected blocks at 225 takes into account both the blocks to be collected in the future, and the blocks that were collected in the past, and may provide a smoother control of the ratio.

At 230, the scaling factor, a, is determined as a function of one or more of the number of free blocks in the solid state storage device, a steady state target number of free blocks, a high target number of free blocks, and a low target number of free blocks. At 235, the scaling factor is applied to the average number of invalid pages to obtain a number of host writes to schedule. The number of GC writes to schedule may be set equal to the average number of valid pages. The scaling factor is thus used to control a ratio of GC writes to host writes to schedule for the solid state storage device.

In one embodiment, the scaling factor is equal to 1 when the number of free blocks is equal to the steady state target number of free blocks and is equal to zero when the number of free blocks is equal to the low target number of free blocks. The scaling factor is highest when the number of free blocks is equal to or higher than the high target number of blocks.

The scaling factor may decrease at a slow rate between the high target number of blocks and the steady state target number of blocks and decreases at a faster rate between the steady state target number of blocks and the low target number of blocks.

In one embodiment, the scaling factor is denoted as a, and is determined according to:

$$α = \{ \begin{matrix}\frac{{B}_{F}}{{M}_{SS} - {M}_{L}} + \frac{{M}_{L}}{{M}_{L} - {M}_{SS}} , & {B}_{F} < {M}_{SS} , \\ ( {B}_{F} - {M}_{ss} ) \frac{β - 1}{{M}_{H} - {M}_{SS}} + 1 , & {M}_{SS} \leq {B}_{F} < {M}_{H} .\end{matrix}$$

where B_{F} is the number of free blocks, M_{L} is the low target number of free blocks, M_{SS} is the steady state target number of free blocks, M_{H} is the high target number of free blocks, and β is a free block rate of decline factor between M_{SS} and M_{H}. β may be arbitrary. In other words, β may be any number. In one embodiment, β may be set between 20 and 100 in some embodiments. A typical value may be 50 for an SSD with 2000 or so physical blocks. Other functions utilizing the above variables may be used in further embodiments.

In one embodiment, the average number of valid pages, C_{V}, and invalid pages, C_{I} is a function of a number, of next blocks in a garbage collection queue waiting to be collected and may be arbitrary. In one embodiment, η may be set between 5 and 10 for the 2000 physical block SSD. In a further embodiment, the average number of valid pages and invalid pages is a function of a number, θ, of previously collected blocks and may be set between 5 and 10 for the 2000 physical block SSD. The average number of valid pages, C_{V}, and invalid pages, C_{I}, in yet a further embodiment is a function of a number of next blocks in a garbage collection queue waiting to be collected and a number of previously collected blocks.

As indicated above, the scaling factor, a, is multiplied by the average number of invalid pages, C_{I}, to obtain the number of host writes, W_{H}, to schedule. The number of GC writes to schedule may then be simply set equal to the average number of valid pages, C_{V}. This establishes a ratio between the GC writes and host writes to schedule to provide better control and availability of the SSD.

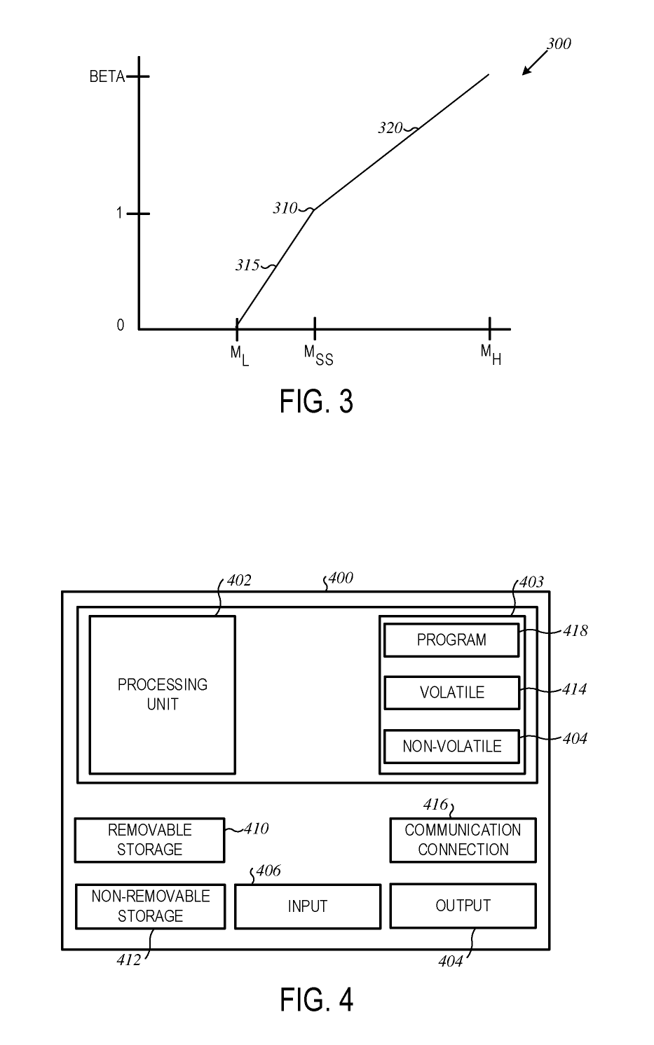

FIG. 3 is a graph 300 illustrating the value of the scaling factor, a, for various thresholds of numbers of target blocks at line 310. The scaling factor varies between 0 at the low target number of blocks, M_{L}, is 1 at the steady state target, M_{SS}, and is β at the high target, M_{H}. Note that the slope of the line 310 representing the scaling factor, a, is steeper as indicated at 315 between M_{L} and M_{SS} in one embodiment that it is between MSS and MH as indicated at 320. The lines at 315 and 320 may be linear, i.e., proportional either side of M_{SS}. Different control algorithms are used, with more aggressive control used as the number of available blocks is lower. In one embodiment, host writes are cut off below M_{L}, while GC may be suspended above M_{H}. In further embodiments, control may be based on combinations of proportional, integral, and derivative (PID) control methods. Thus, the line in FIG. 3 may be may be any arbitrary shape. The line may be curved, straight, sinusoidal etc. as long as it is generally increasing, with 0 at M_{L}, and beta at M_{H}, and close to 1 at M_{SS}.

Because the scaling factor is updated regularly, the controller 120 is able to adapt the ratio of GC writes to host writes on-the-fly in response to varying conditions. Such ability will be beneficial to next generation controllers which may have advanced data management techniques that will cause OP and WA to vary during SSD operation.

FIG. 4 is a block diagram illustrating circuitry for performing methods according to example embodiments. All components need not be used in various embodiments. For example, the host may utilize all the components, while the controller may utilize fewer.

One example computing device in the form of a computer 400 may include a processing unit 402, memory 403, removable storage 410, and non-removable storage 412. Although the example computing device is illustrated and described as computer 400, the computing device may be in different forms in different embodiments. For example, the computing device may be a blade computer or desktop in a data center for implementing a virtual switch, or other computing device including the same or similar elements as illustrated and described with regard to FIG. 4. Devices, such as blade computers or desktop computers are generally collectively referred to as computer devices or user equipment. Further, although the various data storage elements are illustrated as part of the computer 400.

Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 400 may include or have access to a computing environment that includes input 406, output 404, and a communication connection 416. Output 404 may include a display device, such as a touchscreen, that also may serve as an input device. The input 406 may include one or more of a touchscreen, touchpad, mouse, keyboard, camera, one or more device-specific buttons, one or more sensors integrated within or coupled via wired or wireless data connections to the computer 400, and other input devices. For a virtual switch, the input 406 and output 404 may be in the form of a network interface card. The computer in one embodiment operates in a networked environment using a communication connection to connect to one or more remote computers, such as database servers. The remote computer may include a personal computer (PC), server, router, switch, a peer device or other common network node, or the like. The communication connection may include a Local Area Network (LAN), a Wide Area Network (WAN), or other networks.

Computer-readable instructions stored on a computer-readable medium are executable by the processing unit 402 of the computer 400. A hard drive, CD-ROM, and RAM are some examples of articles including a non-transitory computer-readable medium such as a storage device. The terms computer-readable medium and storage device do not include carrier waves to the extent carrier waves are deemed too transitory. For example, a computer program 418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 400 to provide generic access controls in a COM based computer network system having multiple users and servers.

### Examples

In example 1, a method includes obtaining an average number of valid pages per block of the solid state storage device, obtaining an average number of invalid pages per block of the solid state storage device, determining a scaling factor as a function of at least one of the a number of free blocks in the solid state storage device, a steady state target number of free blocks, a high target number of free blocks, and a low target number of free blocks, and applying the scaling factor to the average number of invalid pages to control a ratio of host writes versus garbage collection writes to the solid state storage device.

2. The method of example 1 wherein the scaling factor is equal to 1 when the number of free blocks is equal to the steady state target number of free blocks.

3. The method of any of examples 1-2 wherein the scaling factor is equal to zero when the number of free blocks is equal to the low target number of free blocks.

4. The method of any of examples 1-3 wherein the scaling factor is highest when the number of free blocks is equal to or higher than the high target number of blocks.

5. The method of example 4 wherein the scaling factor decreases at a slow rate between the high target number of blocks and the steady state target number of blocks and decreases at a faster rate between the steady state target number of blocks and the low target number of blocks.

6. The method of any of examples 1-5 wherein the scaling factor is determined as a function of B_{F}— the number of free blocks, M_{L}—a low target number of blocks, M_{SS}—a steady state number of target blocks, M_{H}—a high target number of blocks, and β—a free block rate of decline factor between M_{SS} and M_{H}.

7. The method of example 6 wherein β is arbitrary.

8. The method of any of examples 1-7 wherein the average number of valid pages and invalid pages is a function of a number of next blocks in a garbage collection queue waiting to be collected.

9. The method of example 8 wherein the number of next blocks is between 5 and 10.

10. The method of any of examples 1-9 wherein the average number of valid pages and invalid pages is a function of a number of previously collected blocks.

11. The method of example 10 wherein the number of previously collected blocks is arbitrary.

12. The method of any of examples 1-11 wherein the average number of valid pages and invalid pages is a function of a number of next blocks in a garbage collection queue waiting to be collected and a number of previously collected blocks.

13. In example 13, a system includes a processor and a storage device coupled to the processor and having instructions for causing the processor to perform operations. The operations include obtaining an average number of valid pages value per block of the solid state storage device, obtaining an average number of invalid pages value per block of the solid state storage device, determining a scaling factor as a function of at least one of a number of free blocks in the solid state storage device, a steady state target number of free blocks, a high target number of free blocks, and a low target number of free blocks, and applying the scaling factor to the average number of invalid blocks to control a ratio of host writes versus garbage collection writes to the solid state storage device.

14. The system of example 13 wherein the scaling factor is equal to 1 when the number of free blocks is equal to the steady state target number of free blocks, wherein the scaling factor is equal to zero when the number of free blocks is equal to the low target number of free blocks, and wherein the scaling factor is highest when the number of free blocks is equal to or higher than the high target number of blocks.

15. The system of example 14 wherein the scaling factor decreases at a slow rate between the high target number of blocks and the steady state target number of blocks and decreases at a faster rate between the steady state target number of blocks and the low target number of blocks.

16. The system of any of examples 13-15 wherein the scaling factor is determined as a function of at least one of B_{F}— the number of free blocks, M_{L}—a low target number of blocks, M_{SS}—a steady state number of target blocks, M_{H}—a high target number of blocks, and β—a free block rate of decline factor between M_{SS} and M_{H}.

17. The system of example 16 wherein β is any number, wherein the average number of valid pages and invalid pages is a function of a number of next blocks in a garbage collection queue waiting to be collected, wherein the average number of valid pages and invalid pages is a function of a number of previously collected blocks, or wherein the average number of valid pages and invalid pages is a function of a number of next blocks in a garbage collection queue waiting to be collected and a number of previously collected blocks.

18. In example 18, a computer readable storage device has instructions stored thereon for execution by a computer to perform operations. The operations include obtaining an average number of valid pages value per block of the solid state storage device, obtaining an average number of invalid pages value per block of the solid state storage device, determining a scaling factor as a function of at least one of a number of free blocks in the solid state storage device, a steady state target number of free blocks, a high target number of free blocks, and a low target number of free blocks, and applying the scaling factor to the average number of invalid blocks to control a ratio of host writes versus garbage collection writes to the solid state storage device.

19. The computer readable storage device of example 18 wherein the scaling factor is equal to 1 when the number of free blocks is equal to the steady state target number of free blocks, wherein the scaling factor is equal to zero when the number of free blocks is equal to the low target number of free blocks, and wherein the scaling factor is highest when the number of free blocks is equal to or higher than the high target number of blocks.

20. The computer readable storage device of any of examples 18-19 wherein the scaling factor is determined as a function of at least one of B_{F}— the number of free blocks, M_{L}—a low target number of blocks, M_{SS}—a steady state number of target blocks, M_{H}—a high target number of blocks, and β—a free block rate of decline factor between M_{SS} and M_{H}.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
obtaining an average number of valid pages per block of the solid state storage device;
obtaining an average number of invalid pages per block of the solid state storage device;
determining a scaling factor as a function of at least one of the number of free blocks in the solid state storage device, a steady state target number of free blocks, a high target number of free blocks, and a low target number of free blocks; and
applying the scaling factor to the average number of invalid pages to control a ratio of host writes versus garbage collection writes to the solid state storage device.

2. The method of claim 1 wherein the scaling factor is equal to 1 when the number of free blocks is equal to the steady state target number of free blocks.

3. The method of claim 1 wherein the scaling factor is equal to zero when the number of free blocks is equal to the low target number of free blocks.

4. The method of claim 1 wherein the scaling factor is highest when the number of free blocks is equal to or higher than the high target number of blocks.

5. The method of claim 4 wherein the scaling factor decreases at a slow rate between the high target number of blocks and the steady state target number of blocks and decreases at a faster rate between the steady state target number of blocks and the low target number of blocks.

6. The method of claim 1 wherein the scaling factor is determined as a function of B_{F}—the number of free blocks, M_{L}—a low target number of blocks, M_{SS}—a steady state number of target blocks, M_{H}—a high target number of blocks, and β—a free block rate of decline factor between M_{SS} and M_{H}.

7. The method of claim 6 wherein β is arbitrary.

8. The method of claim 1 wherein the average number of valid pages and invalid pages is a function of a number of next blocks in a garbage collection queue waiting to be collected.

9. The method of claim 8 wherein the number of next blocks is between 5 and 10.

10. The method of claim 1 wherein the average number of valid pages and invalid pages is a function of a number of previously collected blocks.

11. The method of claim 10 wherein the number of previously collected blocks is arbitrary.

12. The method of claim 1 wherein the average number of valid pages and invalid pages is a function of a number of next blocks in a garbage collection queue waiting to be collected and a number of previously collected blocks.

13. A system comprising:
a processor; and
a storage device coupled to the processor and having instructions for causing the processor to perform operations comprising:
obtaining an average number of valid pages value per block of the solid state storage device;
obtaining an average number of invalid pages value per block of the solid state storage device;
determining a scaling factor as a function of at least one of a number of free blocks in the solid state storage device, a steady state target number of free blocks, a high target number of free blocks, and a low target number of free blocks; and
applying the scaling factor to the average number of invalid blocks to control a ratio of host writes versus garbage collection writes to the solid state storage device.

14. The system of claim 13 wherein the scaling factor is equal to 1 when the number of free blocks is equal to the steady state target number of free blocks, wherein the scaling factor is equal to zero when the number of free blocks is equal to the low target number of free blocks, and wherein the scaling factor is highest when the number of free blocks is equal to or higher than the high target number of blocks.

15. The system of claim 14 wherein the scaling factor decreases at a slow rate between the high target number of blocks and the steady state target number of blocks and decreases at a faster rate between the steady state target number of blocks and the low target number of blocks.

16. The system of claim 13 wherein the scaling factor is determined as a function of at least one of B_{F}— the number of free blocks, M_{L}—a low target number of blocks, M_{SS}—a steady state number of target blocks, M_{H}—a high target number of blocks, and β—a free block rate of decline factor between M_{SS} and M_{H}.

17. The system of claim 16 wherein β is any number, wherein the average number of valid pages and invalid pages is a function of a number of next blocks in a garbage collection queue waiting to be collected, wherein the average number of valid pages and invalid pages is a function of a number of previously collected blocks, or wherein the average number of valid pages and invalid pages is a function of a number of next blocks in a garbage collection queue waiting to be collected and a number of previously collected blocks.

18. A computer readable storage device having instructions stored thereon for execution by a computer to perform operations comprising:
obtaining an average number of valid pages value per block of the solid state storage device;
obtaining an average number of invalid pages value per block of the solid state storage device;
determining a scaling factor as a function of at least one of a number of free blocks in the solid state storage device, a steady state target number of free blocks, a high target number of free blocks, and a low target number of free blocks; and
applying the scaling factor to the average number of invalid blocks to control a ratio of host writes versus garbage collection writes to the solid state storage device.

19. The computer readable storage device of claim 18 wherein the scaling factor is equal to 1 when the number of free blocks is equal to the steady state target number of free blocks, wherein the scaling factor is equal to zero when the number of free blocks is equal to the low target number of free blocks, and wherein the scaling factor is highest when the number of free blocks is equal to or higher than the high target number of blocks.

20. The computer readable storage device of claim 18 wherein the scaling factor is determined as a function of at least one of B_{F}— the number of free blocks, M_{L}—a low target number of blocks, M_{SS}—a steady state number of target blocks, M_{H}—a high target number of blocks, and β—a free block rate of decline factor between M_{SS} and M_{H}.
